(19) United States
(12) Patent Application Publication
(10) Pub. No.: US 2024/0052634 A1
(43) Pub. Date: Feb. 15, 2024

(54) POST-TENSIONED CONCRETE WITH FIBERS FOR LONG STRIPS

(71) Applicants: NV Bekaert SA, Zwevegem (BE); CCL STRESSING INTERNATIONAL LTD, Leeds (GB)

(72) Inventors: Hendrik THOOFT, Welden (BE); Gerhard VITT, Pfungstadt (DE); Carol HAYEK, Leeds (GB)

(73) Assignees: NV Bekaert SA, Zwevegem, BE (BE); CCL STRESSING INTERNATIONAL LTD, Leeds (GB)

(21) Appl. No.: 18/269,342

(22) PCT Filed: Dec. 23, 2021
(86) PCT No.: PCT/EP2021/087502

§ 371 Date: Jun. 23, 2023

(30) Foreign Application Priority Data
Dec. 23, 2020 (EP) 20250006.2

(51) Int. Cl. E04C 5/01; C04B 14/48; E04C 2/06

(52) U.S. Cl. CPC E04C 5/012; C04B 14/48; E04C 2/06; C04B 2201/50

(57) ABSTRACT

The present invention concerns a concrete strip, the strip comprising conventional concrete and a combined reinforcement of both post-tension steel strands and fibers, said post-tension steel strands—having a diameter ranging from 5 mm to 20 mm, —having a tensile strength higher than 1700 MPa, said fibers being either steel fibers and being present in a dosage ranging from 5 kg/m³ to 90 kg/m³ or being non-steel fibers and being present in a dosage ranging from 0.6 kg/m³ to 25 kg/m³, whereby the strip has a thickness, whereby further the length of the strip is according to the formula:length of the strip>30×strip thickness.

### TECHNICAL FIELD

The invention relates to a concrete strip comprising conventional concrete and a combined reinforcement of both post-tension steel strands and fibers,
whereby further the strip has a thickness, whereby further the length of the strip is according to the formula:
length of the strip>30×strip thickness.

### BACKGROUND ART

Post-tensioned concrete is a variant of pre-stressed concrete where the tendons, i.e. the post tension steel strands, are tensioned after the surrounding concrete structure has been cast and hardened. It is a practice known in the field of civil engineering since the middle of the twentieth century.

Steel fiber reinforced concrete is concrete where the reinforcement is provided by short pieces of steel wire that are spread in the concrete. U.S. Pat. No. 1,633,219 disclosed the reinforcement of concrete pipes by means of pieces of steel wire. Other prior art publications U.S. Pat. Nos. 3,429,094, 3,500,728 and 3,808,085 reflect initial work done by the Batelle Development Corporation. The steel fibers were further improved and industrialized by NV Bekaert SA, amongst others by providing anchorage ends at both ends of the pieces of steel wire, see U.S. Pat. No. 3,900,667. Another relevant improvement was disclosed in U.S. Pat. No. 4,284,667 and related to the introduction of glued steel fibers in order to mitigate problems of mixability in concrete. Flattening the bent anchorage ends of steel fibers, as disclosed in EP-B1-0 851 957, increased the anchorage of the steel fibers in concrete. The supply of steel fibers in a chain package was disclosed in EP-B1-1 383 634.

Both reinforcement techniques, post-tensioned concrete and fiber reinforced concrete such as steel fiber reinforced concrete not only exist as such but also in combination. The purpose was to combine the advantages of both reinforcement types to obtain an efficient and reliable reinforced concrete strip.

Prior art concrete strips with combined reinforcement of both post-tension strands and fibers suffer especially for example from an overdesign or from a complex design. In an attempt to stay on the very safe side and to meet the specifications, the dosage of steel fibers is often so high that problems such as ball forming occur during mixing of the steel fibers in the non-cured concrete, despite the existence of prior art solutions. Alternatively, or in addition to this, the distance between two neighbouring post-tension strands or between two neighbouring bundles of post-tension strands cannot exceed certain maximum spacing, causing a lot of labour when installing the post-tension strands, attaching anchors and applying tension. In yet other prior art embodiments the composition of the concrete is such that shrinkage during curing is limited, i.e. for example a low shrinkage concrete or a shrinkage compensating concrete composition may be selected.

An example of a complex design of a concrete strip with reinforcement by both post-tension steel strands and steel fibers is disclosed in NZ-A-220 693. This prior art concrete strip has an under and upper skin layer with steel fibers with a core layer in-between with post-tension tendons.

The present invention especially allows especially for big spans of strip and/or for particularly easy/fast construction of for example flooring or foundations or pavements, especially for roads, runways or docks, whereby the strips can be indoors and/or outdoors. The present invention may also contribute to increased fatigue resistance and/or the number of load cycles, especially at high stresses. Furthermore, the present invention may allow for easier and/or faster installation. The present invention may further contribute to increase the structural capacity for flexure, deflection, settlement, shear, punching shear, structural integrity, temperature resistance and/or resistance to shrinkage. The present invention may also contribute to improve the resistance of the strip to temperature gradients (top/bottom) and/or temperature fluctuations, especially seasonal fluctuations and/or day/night fluctuations. Furthermore, the present invention advantageously allows for example that post tensioning strands can remain unstressed, even without partial stressing, without the need for shrinkage reinforcement at least for a couple of days after pouring the strip.

### DISCLOSURE OF INVENTION

It is a general aspect of the invention to avoid the disadvantages of the prior art.

It is a further general aspect of the invention to avoid overdesign and/or to simplify the reinforcement scheme.

It is another aspect of the invention to provide a combination reinforcement of both post-tension strands and fibers to reinforce concrete strips and/or extend their span efficiently and effectively as well as to contribute to increased fatigue resistance, especially to external loads such as for example but not limited to those associated with passing trucks, forklifts, airplanes or associated with temperature fluctuations, and/or increase the number of load cycles, especially at high stresses.

It is still another aspect of the invention to provide a combination reinforcement of both post-tension strands and fibers for conventional concrete strips.

According to the invention, there is provided a concrete strip, the strip comprising conventional concrete and a combined reinforcement of both post-tension steel strands and fibers,
said post-tension steel strands
   having a diameter ranging from 5 mm to 20 mm,
   having a tensile strength higher than 1700 MPa,
said fibers being either steel fibers and being present in a dosage ranging from 5 kg/m³ to 90 kg/m³ or being other non-steel fibers and being present in a dosage ranging from 0.6 kg/m³ to 25 kg/m³,
whereby the strip has a thickness, whereby further the length of the strip is according to the formula:

length of the strip>30×strip thickness.

A concrete strip in the sense of the present invention may thereby preferably for example be a concrete slab that is preferably poured in one step or in one go or in one day, especially for example cast in one step to build up the whole thickness of the strip and/or made without casting multiple layers. This may mean that the strip is preparable made up of the same material across the whole thickness of the strip. This may mean that a strip according to the invention does therefore especially not comprise regions or parts of lower density, especially no aggregated and/or aerated parts and/or no polymer based insulating material, further more preferred no aggregated and/or aerated blocks and/or no polymer based insulating material, which has/have a lower density, especially compared to cast concrete. The length of the strip may thereby be preferably for example higher than thirty times the strip thickness according to the formula: length of the strip>30×strip thickness. In an embodiment of the present invention, the length over width ratio of the strip may be for example between >1.5 and 100, preferably between >2.0 and 75, further preferred between 2.5 and 50, even further preferred between >2.5 and 35. The present invention may thereby limit the need for reinforcement and/or limit the crack formation and/or crack propagation, especially for particularly long strips/slabs.

In an embodiment of the present invention, the strip may have especially for example a thickness according to the formula:

length of the strip>33×strip thickness,
preferably according to the formula:

length of the strip>50×strip thickness,
further preferred according to the formula:

length of the strip>500×strip thickness and/or
the strip may for example especially satisfy the formula:

30×strip thickness<length of the strip<1000×strip thickness,
preferably
100×strip thickness<length of the strip<750×strip thickness. The length of the strip may thereby be preferably for example higher than thirty-three or fifty or five hundred times the strip thickness according to the formulas above. The length of the strip may thereby also be for example between thirty times the strip thickness and thousand times the strip thickness or between one hundred times the strip thickness and seven hundred fifty times the strip thickness according to the formulas above. The present invention thereby allows for particularly long strips, especially with a length preferably for example >25 m, preferably >50 m, further preferred >100 m, even further preferred >110 m, preferably between >50 m and 150 m or between >100 m and 140 m and/or a thickness of the strip preferably for example between 10 and 75 cm, preferably 15 and 60 cm.

The tendons or post-tension steel strands may have a diameter ranging from 5 mm to 20 mm, e.g. from 6 mm to 20 mm, e.g. from 6.5 mm to 18.0 mm. The post-tension steel strands may especially for example have a tensile strength between 1700 MPa and 3500 MPa, preferably between higher than 1700 MPa and 3000 MPa, further preferred higher than 1800 MPa, even further preferred higher than 1900 MPa or higher than 2000 MPa. Post-tensioned steel strands are thereby tensioned after the concrete is cast. In contrast, pre-tensioning is used mostly for pre-cast elements casted off-site with tendons fixed to a form and being tensioned before any concrete is cast.

The tendons or post-tension steel strands may be bonded or unbonded. In addition, the steel strands may preferably for example be present in bundles.

Particularly with a view to be used as post-tension steel strand, the steel strand preferably has a low relaxation behaviour, i.e. a high yield point at 0.1% elongation. The yield point at 0.1% can be considered as the maximum elastic limit. Below the yield point, the post-tension strand will remain in elastic mode. Above the yield point, the post-tension strand may start to elongate in plastic mode, i.e. an elongation that is not reversible. Preferably, the ratio of the yield strength Rpoi to the tensile strength R m is higher than 0.75, alternatively equal to or higher than 0.85, preferably equal to or higher than 0.90, further preferred equal to or higher than 0.95, even further preferred equal to or higher than 0.98

Low relaxation post-tension steel strands may have relaxation losses of not more than 2.5% when initially loaded to 70% of specified minimum breaking strength or not more than 3.5% when loaded to 80% of specified minimum breaking strength of the post-tension steel strand after 1000 hours.

The fibers can be steel fibers and are present in a dosage ranging from 5 kg/m³ to 90 kg/m³, preferably whereby steel fibers are present in the strip in a dosage ranging from 7 kg/m³ to 75 kg/m³, preferably from 7 kg/m³ to <65 kg/m³, preferably from 10 kg/m³ to 60 kg/m³, preferably 15 kg/m³ to 50 kg/m³, further preferred 20 kg/m³ to 45 kg/m³, even further preferred between >15 kg/m³ to <40 kg/m³, even further preferred between >20 kg/m³ to <35 kg/m³ or alternatively >45 kg/m³ to 60 or <65 kg/m³. Higher dosages of steel fibers may there for example contribute to increased fatigue resistance and/or to increase the number of load cycles, especially at high stresses.

The fibers can be other non-steel fibers and are present in a dosage ranging from >0.6 kg/m³ to 15 kg/m³, e.g. from 1.2 kg/m³ to 7.0 kg/m³, e.g. from 2.5 kg/m³ to 5.0 kg/m³.

The fibers are present in all parts of the concrete strip, i.e. the concrete strip is preferably a monolithic strip and the fibers are substantially homogeneously or homogeneously distributed in the concrete strip. Substantially homogeneously may thereby mean for example except for a very thin (preferably below 10 mm, further preferred below 6 mm) upper skin layer that is applied to provide a flat and wear resistant surface to the strip and to avoid fibers from protruding. In an embodiment, the strip may preferably be cast in one or multiple steps, preferably in one step. In another embodiment, several consecutive strips can thereby be attached together or placed side-by-side to cover a larger area.

Dosages of fibers of 5.0 kg/m³ to 40 kg/m³ in case of steel fibers and 0.6 kg/m³ to 25 kg/m³ in case of other non-steel fibers are low to moderate in comparison with prior art dosages of more than 40 kg/m³ or more than 9.0 kg/m³. Such low to moderate dosages may for example further allow integrating the fibers in a more homogeneous way in the concrete and facilitate the mixing of the fibers in the concrete.

Conventional concrete may thereby preferably have a characteristic compressive cube strength or comparable cylinder strength 25 N/mm² or higher, preferably 28 N/mm² or higher, further preferred 30 N/mm² or higher. More preferably, conventional concrete has a strength equal to or higher than the strength of concrete of the C20/25 strength classes as defined in EN206 or equivalent national code requirements and smaller than or equal to the strength of concrete of the C50/60 strength classes as defined in EN206. These types of concrete are widely available and avoid adding ingredients that reduce the shrinkage during hardening. For the avoidance of doubt, self-compacting concrete is considered as conventional concrete. In a preferred embodiment, the strip does not contain any further reinforcement elements, such as for example rebars or steel nets or steel mesh beside steel fibers and post-tensioning steel strands within the body of the strip, especially there may no rebars neither at the top nor at the bottom within the body of the strip. In the present invention, there may especially be no post-tension steel strands and/or rebars and/or steel mesh and/or steel nets necessary or foreseen within the body of the strip in the width direction (corresponding to the shorter direction) and/or in the length direction (corresponding to the longer direction) of the strip. However, dowels that may be provided or foreseen at the end of the strip and/or reinforcement that may be provided or foreseen at anchorage zones, especially at the anchor points, of the post tension steel strands (i.e. post-tensioning anchors) are, in the sense of the present invention, not considered further reinforcement elements within the body of the strip.

In a preferable embodiment of the invention, the fibers are steel fibers and have a straight middle portion and anchorage ends at both ends.

Most preferably the tensile strength of the middle portion is between 1700 MPa and 3500 MPa, preferably between higher than 1700 MPa and 3000 MPa, further preferred higher than 1800 MPa, even further preferred higher than 1900 MPa or higher than 2000 MPa.

The anchorage ends preferably each comprise three or four bent sections. Examples of such steel fibers are disclosed in EP-B1-2 652 221 and in EP-B1-2 652 222.

In an embodiment of the invention, the steel fibers have for example an elongation capacity of between 2.5 and 12%, preferably at least 2.5%, preferably at least 3.5%, further preferred at least 4.5%, even more preferred a least 5.5%. Elongation capacity in a certain range in the sense of the present invention may thereby especially for example refer to an elongation at maximum load in said range. In another preferable embodiment of the invention, the middle portion of the steel fibers may have for example have an elongation at maximum load higher than 4%, e.g. higher than 5%, e.g. higher than 5.5%. By the elongation at maximum load is understood the total elastic and plastic elongation of a straight steel fibre sample at maximum load during the tensile testing test. This means that structural elongation for example by straightening may preferably not be taken into account when considering elongation at maximum load.

In the present invention, the post-tension steel strands may be straight and/or draped. Preferably the post-tension steel strands are arranged so that in any cross-section through the strip all steel strands going in one (i.e. in the same) direction (i.e. either lengthwise or widthwise) are arranged along one line and/or at the same elevation. Draped may thereby mean that they are positioned for example to take away as much as possible the tensile stresses in the concrete, so that they may arranged in a sinusoidal way when looking at a longitudinal section, especially whereby they may for example be positioned in the upper half of the concrete strip in a portion of the strip and along of the length of the strip go down to be positioned in the lower half of the concrete strip, go up again and so forth. In an embodiment of the invention, the post tensioning strands may be for example draped and/or straight and/or arranged in the middle or the higher third or the lower third of the strip.

In an embodiment of the invention, the post-tension steel strands may be in a distributed-distributed steel strands configuration, in a banded-banded steel strands configuration, in a banded-distributed steel strands configuration or in a configuration resulting from any combination thereof, and/or the post tension steel strands can be arranged in any configuration, preferably without any maximum and/or minimum spacing requirements and/or the post-tension steel strand may be used for bonded or unbonded post-tensioning and/or the anchors for the post-tension steel strands may be designed as described for example in patent application U.S. 63/052,283 and/or wherein the fibers are substantially homogenously or homogeneously distributed in the strip. A banded or banded-banded configuration of steel strands may thereby allow to keep the strip freer from steel strands, so as to allow for example for more design freedom or safe drilling through the strips. Bonded post-tensioning may thereby use bonded strands that may be bonded to the concrete of the strips for example using grout, so that even in case of a problem an anchor structural integrity is preserved through the bonding.

In an embodiment of the invention,
a combination the post-tension steel strands and steel fibers increase fatigue load bearing capacity for the same number of load repetitions by 25 to 500%, preferably by 50 to 250%, further preferred by >50% to 100%. An increase is thereby especially for example to be measured over a strip that does either not comprise steel strands or that does not comprise steel fibers but is otherwise identical. This may particularly be useful to withstand repetition loads due to for example trucks, airplanes, forklifts, reach stackers and/or point loads from groups of containers. A strip according to the invention may thereby have for example a load bearing capacity of at least 20 kN/m², preferably between 20 and 60 kN/m². In a further aspect, the invention also concerns a method or use for casting particularly long strip according to the invention as described herein, preferably for example for casting such strips with a length of >25 m, further preferred with a length>50 m, further preferred with a length>100 m, further preferred with a length>110 m, especially comprising the steps of:
using conventional concrete and a combined reinforcement of both post-tension steel strands and fibers, said post-tension steel strands
   having a diameter ranging from 5 mm to 20 mm,
   having a tensile strength higher than 1700 MPa,
said fibers being either steel fibers and being present in a dosage ranging from kg/m³ to 90 kg/m³ or being other non-steel fibers and being present in a dosage ranging from 0.6 kg/m³ to 25 kg/m³,
and casting a strip that has a thickness, whereby further the length of the strip is according to the formula:
length of the strip>30×strip thickness and/or the strip having for example a length of >25 m, preferably >50 m, further preferred >100 m, further preferred >110 m preferably between >50 m and 150 m. and/or a for example thickness of the strip being preferably for example between 10 and 75 cm, preferably 15 and 60 cm. The strips cast according to the method or use described herein can thereby have all features or feature combinations of a strip according to the invention, especially wherein steel fibers present in a dosage ranging from between >15 kg/m³ to <40 kg/m³, preferably between >20 kg/m³ to <35 kg/m³ and/or wherein the strip is a concrete slab that is preferably poured in one step or in one go or in one day and/or wherein the steel fibers are present in all parts of the concrete strip and/or the concrete strip is preferably a monolithic strip and/or wherein the length over width ratio of the strip may be for example between >1.5 and 100, preferably between >2.0 and 75, further preferred between 2.5 and 50, even further preferred between >2.5 and 35. The strip may thereby especially for example have a width of for example between 4 m and 17 m, preferably between 5 m and 15 m, preferably between 6 m to 12 m.

### MODE(S) FOR CARRYING OUT THE INVENTION

In some embodiments, a post-tension steel strand may also be arranged in the middle of the strip.

However, no position can guarantee the total absence of tensile stresses. Within the context of the present invention, post-tension steel strands may therefore be designed especially for example to take up and compensate the tensile stresses that may originate during hardening and shrinkage of a concrete and/or from seasonal or daily temperature changes in addition to applied loads. The post-tension steel strands are preferably of a sufficiently high tensile strength, i.e. above 1700 MPa or even above 1800 MPa, so that for example conventional concrete can be used and/or ingredients to compensate shrinkage can preferably be avoided.

The fibers are mixed in the concrete as homogeneously as possible so that may preferably be present over the whole volume of the strip and able to take tensile stresses caused by various loads.

Post-Tension Steel Strand

A typical post-tension steel strand may have for example a 1+6 construction with a core steel wire and six layer steel wires twisted around the core steel wire. In an embodiment, the post-tension steel strand may be in a non-compacted form.

In an alternative preferable embodiment, the post-tension steel strand may be in a compacted form. In this compacted form, the six layer steel wires no longer have a circular cross-section but a cross-section in the form of a trapezium with rounded edges. A compacted post-tension steel strand has less voids and more steel per cross-sectional area.

As mentioned, the post-tension steel strand may have a high yield point, i.e. the yield force at 0.1% elongation is high. The ratio yield force F_{p0,1} to breaking force Fₘ is higher than 75%, preferably equal to or higher than 80%, e.g. equal to or higher than 85%, further preferred equal to or higher than 90%, even further preferred equal to or higher than 95%, even further preferred equal to or higher than 98%.

A typical steel composition of a post-tension steel strand is a minimum carbon content of 0.65%, a manganese content ranging from 0.20% to 0.80%, a silicon content ranging from 0.10% to 0.40%, a maximum sulfur content of 0.03%, a maximum phosphorus content of 0.30%, the remainder being iron, all percentages being percentages by weight.

Most preferably, the carbon content is higher than 0.75%, e.g. higher than 0.80%. Other elements as copper or chromium may be present in amounts not greater than 0.40%.

All steel wires may be provided with a metallic coating, such as zinc or a zinc aluminium alloy. A zinc aluminium coating has a better overall corrosion resistance than zinc. In contrast with zinc, the zinc aluminium coating is temperature resistant. Still in contrast with zinc, there is no flaking with the zinc aluminium alloy when exposed to high temperatures.

A zinc aluminium coating may have an aluminium content ranging from 2 percent by weight to 12 percent by weight, e.g. ranging from 3% to 11%.

A preferable composition lies around the eutectoid position: Al about 5 percent. The zinc alloy coating may further have a wetting agent such as lanthanum or cerium in an amount less than 0.1 percent of the zinc alloy. The remainder of the coating is zinc and unavoidable impurities.

Another preferable composition contains about 10% aluminium. This increased amount of aluminium provides a better corrosion protection then the eutectoid composition with about 5% of aluminium.

Other elements such as silicon (Si) and magnesium (Mg) may be added to the zinc aluminium coating. With a view to optimizing the corrosion resistance, a particular good alloy comprises 2% to 10% aluminium and 0.2% to 3.0% magnesium, the remainder being zinc. An example is 5% Al, 0.5% Mg and the rest being Zn.

An example of a post-tension steel strand is as follows:
diameter 15.2 mm;
steel section 166 mm²;
E-modulus: 196000 MPa;
breaking load Fₘ: 338000 N;
yield force F_{p0,1}: 299021 N;
tensile strength Rₘ 2033 MPa.

Steel Fiber

Steel fibers adapted to be used in the present invention typically have a middle portion with a diameter D ranging from 0.30 mm to 1.30 mm, e.g. ranging from 0.50 mm to 1.1 mm. The steel fibers have a length [symbol] so that the length-to-diameter ratio [symbol] D ranges from 40 to 100.

Preferably, the steel fibers have ends to improve the anchorage in concrete. These ends may be in the form of bent sections, flattenings, undulations or thickened parts. Most preferably, the ends are in the form of three or more bent sections. In one embodiment, steel fibers may be glued.

FIG. 1 shows a side view of a strip (1) according to the invention having a length (L) and a thickness (T) with posttensioning strands (2).

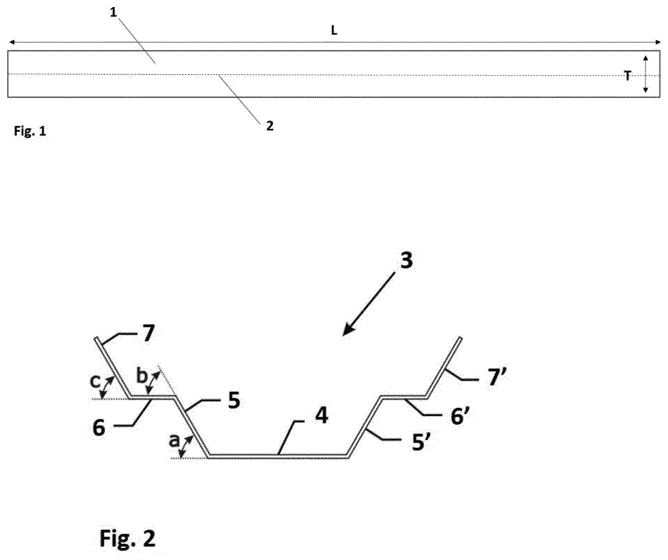

FIG. 2 illustrates a preferable embodiment of a steel fibre (3). The steel fibre (3) has a straight middle portion (4). At one end of the middle portion (4), there are three bent sections (5), (6) and (7). At the other end of the middle portion (4) there are also three bent sections (5′), (6′) and (7′). Bent sections (5), (5′) make an angle (a) with respect to a line forming an extension to the middle portion (4). Bent sections (6), (6′) make an angle (b) with respect to a line forming an extension to bent sections (5), (5′). Bent sections (7), (7′) make an angle (c) with respect to bent sections (6), (6′).

The length [symbol] of the steel fibre (3) may range between 50 mm and 75 mm and is typically 60 mm.

The diameter of the steel fibre may range between 0.80 mm and 1.20 mm.

Typical values are 0.90 mm or 1.05 mm.

The length of the bent sections (5), (5′), (6), (6′), (7) and (7′) may range between 2.0 mm and 5.0 mm. Typical values are 3.2 mm, 3.4 mm or 3.7 mm.

The angles (a), (b) and (c) may range between 20° and 50°, e.g. between 24° and 47°.

The steel fibers may or may not be provided with a corrosion resistant coating such as zinc or a zinc aluminium alloy.

In an embodiment of the present invention, zinc coated steel fibres may be used in combination with post-tensioned strands, whereby an inhibitor for hydrogen embrittlement may be used. An inhibitor for hydrogen embrittlement may thereby by any substance that reduces, slows down or otherwise mitigates hydrogen formation, especially due to zinc-alkali reaction. This may contribute to avoid hydrogen formation due to a zinc-alkali reaction and to avoid subsequent hydrogen embrittlement of the strands. An inhibitor can be added for example as a separate substance or could be added in form of a coating on the fibres as described in EP1853528.

In a particular preferable embodiment of the invention, there may be three or four bent sections at each end of the middle portion.

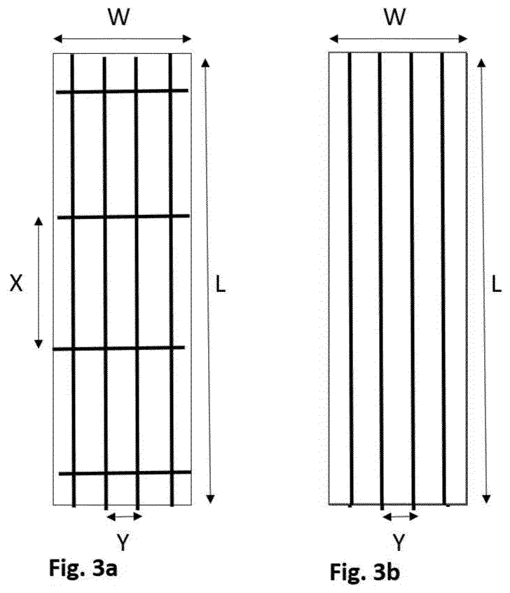

FIG. 3a shows a schematic of a strip according to the invention with a length (L) and a width (W) having a first distance (X) between two post-tensioning strands arranged widthwise along the length (L) as well as a second distance (Y) between two post-tensioning strands arranged lengthwise along the width (W).

FIG. 3b shows a schematic of a strip according to the invention with a length (L) and a width (W) having a distance (Y) between two post-tensioning strands arranged lengthwise along the width (W).

In a preferred embodiment of the invention the first distance (X) may be preferably for example higher than the second distance (Y).

Other Non-Steel Fibers

Examples of other non-steel fibers may be selected from carbon fibers, glass fibers, basalt fibers or other non-steel based fibers, such as fibers based upon polyolefins like polypropylene or polyethylene or based upon other thermoplastics such as polyvinyl alcohol.

Examples of a Strip

### First Example

thickness of concrete strip: 0.30 m

Length of the strip: 120 m

Width 6 m to 12 m
applied load 35 kN/m²
distance between post-tension steel strands: 1.5 m
Quantity of steel fibers: 25 kg/m³

1. A concrete strip, the strip comprising conventional concrete and a combined reinforcement of both post-tension steel strands and fibers,
said post-tension steel strands
having a diameter ranging from 5 mm to 20 mm,
having a tensile strength higher than 1700 MPa,
said fibers being either steel fibers and being present in a dosage ranging from 5 kg/m³ to 90 kg/m³ or being other non-steel fibers and being present in a dosage ranging from 0.6 kg/m³ to 25 kg/m³,
whereby the strip has a thickness, whereby further the length of the strip is according to the formula:
length of the strip>30×strip thickness.

2. The concrete strip according to claim 1,
wherein the length over width ratio of the strip is between >1.5 and 100, preferably between >2.0 and 75, further preferred between 2.5 and 50, even further preferred between >2.5 and 35 and/or wherein the strip has a width of between 4 m and 17 m, preferably between 5 m and 15 m, preferably between 6 m to 12 m and/or wherein the strip is indoors and/or outdoors.

3. The concrete strip according to claim 1,
wherein said conventional concrete has a characteristic compressive cube strength of 25 N/mm² or higher, preferably 28 N/mm² or higher, further preferred 30 N/mm² or higher and/or wherein the strip does not contain any further reinforcement elements, such as especially rebars or steel nets beside steel fibers and/or post-tensioning steel strands within the body of the strip and/or
wherein the strip does not contain post-tension steel strands and/or rebars and/or steel mesh and/or steel nets within the body of the strip in the width direction and/or in the length direction of the strip and/or
wherein the strip is cast in one step and/or wherein the strip is cast in one step to build up the whole thickness of the strip and/or wherein the strip is made without casting multiple layers and/or wherein the strip is made up of the same material across the whole thickness of the strip and/or wherein the post-tension steel strands are arranged so that in any cross-section through the strip all steel strands going in one/the same direction are arranged along one line and/or at the same elevation.

4. The concrete strip according to claim 1,
wherein said fibers are steel fibers or wherein the fibers are glued or wherein said fibers are other non-steel fibers that may be selected from carbon fibers, glass fibers, basalt fibers or other non-steel based fibers, preferably polyolefin fibers, further preferred polypropylene fibers or polyethylene fibers or polyvinyl alcohol fibers.

5. The concrete strip according to claim 1,
wherein the strip has a thickness according to the formula:
length of the strip>33×strip thickness,
preferably wherein the strip has a thickness according to the formula:
length of the strip>50×strip thickness,
further preferred wherein the strip has a thickness according to the formula:
length of the strip>500×strip thickness and/or
wherein the strip satisfies the formula:
30×strip thickness<length of the strip<1000×strip thickness,
preferably
100×strip thickness<length of the strip<750×strip thickness and/or
wherein the strip has a length preferably for example >25 m, preferably >50 m, further preferred >100 m, even further preferred >110 m, preferably between >50 m and 150 m or between >100 m and 140 m and/or has a thickness preferably for example between 10 and 75 cm, preferably 15 and 60 cm.

6. The concrete strip according to claim 1,
wherein said steel fibers comprise anchorage ends at both ends,
said anchorage ends each comprise three or four bent sections and/or
wherein said steel fibers have an elongation capacity of between 2.5 and 12%, preferably at least 2.5%, preferably at least 3.5%, further preferred at least 4.5%, even more preferred a least 5.5%

7. The concrete strip according to claim 1,
whereby steel fibers are present in the strip in a dosage ranging from 7 kg/m³ to 75 kg/m³, preferably from ≥7 kg/m³ to <65 kg/m³, preferably from ≥10 kg/m³ to 60 kg/m³, preferably kg/m³ to 50 kg/m³, further preferred 20 kg/m³ to 45 kg/m³, even further preferred between >kg/m³ to <40 kg/m³, even further preferred between >20 kg/m³ to <35 kg/m³ or alternatively >45 kg/m³ to 60 or <65 kg/m³.

8. The concrete strip according to claim 1,
wherein the post tensioning strands are draped and/or straight and/or arranged in the middle or the higher third or the lower third of the strip.

9. The concrete strip according to claim 1,
wherein the fibers are substantially homogenously or homogeneously distributed in the strip.

10. The concrete strip according to claim 1,
wherein the post-tension steel strands are in a banded-banded steel strands configuration or in a banded-distributed steel strands configuration or in a configuration resulting from any combination thereof, and/or
wherein the post-tension steel strand are used for bonded or unbonded post-tensioning.

11. The concrete strip according to claim 1,
wherein a combination the post-tension steel strands and steel fibers increase fatigue load bearing capacity for the same number of load repetitions by 25 to 500%, preferably by 50 to 250%, further preferred by >50% to 100% and/or the trip has a load bearing capacity of at least 20 kN/m², preferably between 20 and 60 kN/m².

12. A method for casting particularly long strip according to the invention as described herein, especially comprising the steps of:
using conventional concrete and a combined reinforcement of both post-tension steel strands and fibers,
said post-tension steel strands
having a diameter ranging from 5 mm to 20 mm,
having a tensile strength higher than 1700 MPa,
said fibers being either steel fibers and being present in a dosage ranging from 5 kg/m³ to 90 kg/m³ or being other non-steel fibers and being present in a dosage ranging from 0.6 kg/m³ to 25 kg/m³,
and casting a strip that has a thickness, whereby further the length of the strip is according to the formula:
length of the strip>30×strip thickness.

13. The method according to claim 12,
wherein the method is for casting a strip with a length of >25 m, preferably with a length of >50 m, further preferred with a length of >100 m, further preferred with a length of >110 and/or wherein the strip is having a length of >25 m, preferably a length of >50 m, further preferred of >100 m, further preferred with a length>110 m and/or is having a thickness of the strip preferably for example between 10 and 75 cm, preferably 15 and 60 cm and/or wherein the strip is according to the formula: length of the strip>500×strip thickness and/or the strip may for example especially satisfy the formula:
30×strip thickness<length of the strip<1000×strip thickness,
preferably
100×strip thickness<length of the strip<750×strip thickness and/or wherein the strip has a width of between 4 m and 17 m, preferably between 5 m and 15 m, preferably between 6 m to 12 m.

14. The method according to claim 12, wherein steel fibers present in a dosage ranging from between >15 kg/m³ to <40 kg/m³, preferably between >20 kg/m³ to <35 kg/m³ and/or wherein the strip is a concrete slab that is preferably poured in one step or in one go or in one day and/or wherein the strip is cast in one step to build up the whole thickness of the strip and/or wherein the strip is made without casting multiple layers and/or wherein the strip is made up of the same material across the whole thickness of the strip and/or wherein the post-tension steel strands are arranged so that in any cross-section through the strip all steel strands going in one/the same direction are arranged along one line and/or at the same elevation.and/or wherein the steel fibers are present in all parts of the concrete strip and/or the concrete strip is preferably a monolithic strip and/or wherein the length over width ratio of the strip may be for example between >1.5 and 100, preferably between >2.0 and 75, further preferred between 2.5 and 50, even further preferred between >2.5 and 35 and/or wherein said steel fibers comprise anchorage ends at both ends, said anchorage ends each comprise three or four bent sections and/or
wherein said steel fibers have an elongation capacity of between 2.5 and 12%, preferably at least 2.5%, preferably at least 3.5%, further preferred at least 4.5%, even more preferred a least 5.5% and/or wherein the strip is indoors and/or outdoors.

15. The method according to claim 12, wherein a combination the post-tension steel strands and steel fibers increase fatigue load bearing capacity for the same number of load repetitions by 25 to 500%, preferably by 50 to 250%, further preferred by >50% to 100% and/or the strip has a load bearing capacity of at least 20 kN/m², preferably between 20 and 60 kN/m².
